(19) United States
(12) Patent Application Publication
(10) Pub. No.: US 2020/0342774 A1
(43) Pub. Date: Oct. 29, 2020

(54) Visual Indication Apparatus for Drones

(71) Applicant: Hex Technology Limited, Hong Kong (HK)

(72) Inventors: Philip Jonathan ROWSE, Moolap (AU); Chengjun WU, Xiamen (CN)

(21) Appl. No.: 16/856,065

(22) Filed: Apr. 23, 2020

Related U.S. Application Data
(60) Provisional application No. 62/838,287, filed on Apr. 24, 2019.

(51) Int. Cl. G08G 5/00; G09G 5/00; G09G 5/02; G09G 5/22; B64C 39/02; G01S 19/45

(52) U.S. Cl. CPC G08G 5/0047; G09G 5/005; G09G 5/02; B64C 2201/145; B64C 39/024; G01S 19/45; G09G 2370/16; G09G 5/22

(57) ABSTRACT

The present invention provides a navigation controller with real-time visual indication of a specific cardinal direction in relation to a front direction of the navigation controller which allows checking on whether the heading estimation of the UAV is subject to any magnetic interference. The navigation controller comprises a housing comprising a distinctive visual mark for indicating the front direction of the navigation controller; a GNSS satellite signal receiving module and a visual indication module comprising a circular array of visual indicators evenly arranged in a circular ring and configured to generate visual indication of the specific cardinal direction in relation to the front direction of the navigation controller.

### CROSS-REFERENCE TO RELATED APPLICATIONS

This application claims priority to U.S. Provisional Patent Application No. 62/838,287 filed Apr. 24, 2019, the disclosure of which is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to navigation controllers for unmanned aerial vehicle (UAV) or unmanned aircraft system (UAS), and particularly relates to navigation controllers with visual indication of a specific cardinal direction.

### BACKGROUND OF THE INVENTION

Heading estimation of UAV is very important for UAV navigation. In many cases the UAV is subject to magnetic interference from the ground or other nearby interfering sources. However, identifying such interference is not straightforward. Currently, operators have to rely on data shown on ground control station, which are received from the UAV such as a drone through telemetry. Therefore, it is desirable to have an apparatus and method for quick identification of the status of heading estimation of UAV.

### SUMMARY OF THE INVENTION

One objective of the present invention is to provide an apparatus or method with real-time visual indication of navigational information. Another objective of the present invention is to allow an operator of a UAV to check on whether the heading estimation of the UAV is subject to any magnetic interference based on the visual indication of a specific cardinal direction.

According to one aspect of the present invention, a navigation controller with real-time visual indication of navigational information is provided. The navigation module comprises: a satellite signal receiving module comprising an antenna configured to receive satellite signals from a global navigation satellite system (GNSS); a processing module configured to extract the navigational information on basis of the received satellite signals; and a plurality of visual indicators configured to provide visual indication of the extracted navigational information.

According to another aspect of the present invention, a navigation controller with real-time visual indication of a specific cardinal direction in relation to a front direction of the navigation controller. The navigation module comprises: a visual mark indicating a front direction of the navigation controller; a satellite signal receiving module comprising an antenna configured to receive satellite signals from a GNSS; a processing module configured to extract the specific cardinal direction on basis of the received satellite signals; and a circular array of visual indicators configured to provide visual indication of the specific cardinal direction in relation to the front direction of the navigation controller.

Preferably, each visual indicator is associated with a direction having an indexing angle with respect to the front direction of the navigation controller. The processing module is further configured to determine a relative angle between the front direction and the specific cardinal direction, and compare each of the indexing angles of the plurality visual indicators with the determined relative angle to identify a visual indicator with the indexing angle of a value closest to the relative angle. The identified visual indicator is then configured to have an appearance which is distinctly different from the other visual indicators.

### BRIEF DESCRIPTION OF THE DRAWINGS

Embodiments of the invention are described in more detail hereinafter with reference to the drawings, in which:

FIG. 1 depicts a block diagram of a navigation device in accordance with an exemplary embodiment of the present invention;

FIG. 2A depicts an isometric view of a navigation device in accordance with an exemplary embodiment of the present invention;

FIG. 2B depicts a side view of the navigation device in accordance with an exemplary embodiment of the present invention;

FIG. 3A depicts a partial explosive view of the navigation device in accordance with an exemplary embodiment of the present invention;

FIG. 3B depicts another partial explosive view from another view angle of the navigation device in accordance with an exemplary embodiment of the present invention;

FIG. 4 depicts a top view of a print circuit board (PCB) assembly of the navigation device in accordance with an exemplary embodiment of the present invention;

FIG. 5 depicts a circuit diagram of a radio frequency (RF) section on the PCB of the navigation device in accordance with an exemplary embodiment of the present invention;

FIG. 6 depicts a circuit diagram of a controller area network (CAN) interfacing module of the navigation device in accordance with an exemplary embodiment of the present invention;

FIG. 7 depicts a circuit diagram of dual power supply for the CAN interfacing module of the navigation device in accordance with an exemplary embodiment of the present invention; and

FIG. 8 depicts a top view of a visual indication module of the navigation device in accordance with an exemplary embodiment of the present invention.

### DETAILED DESCRIPTION

In the following description, for purposes of explanation, numerous specific details are set forth in order to provide a thorough understanding of the embodiment of the disclosure. However, it will be apparent to practitioner skilled in the art that the present disclosure may be practiced without these specific details or with an equivalent arrangement.

Although the invention is hereinafter described in embodiments predominantly based on an example application of a UAV navigation controller, the present invention will also be applicable to any surveying and mapping applications.

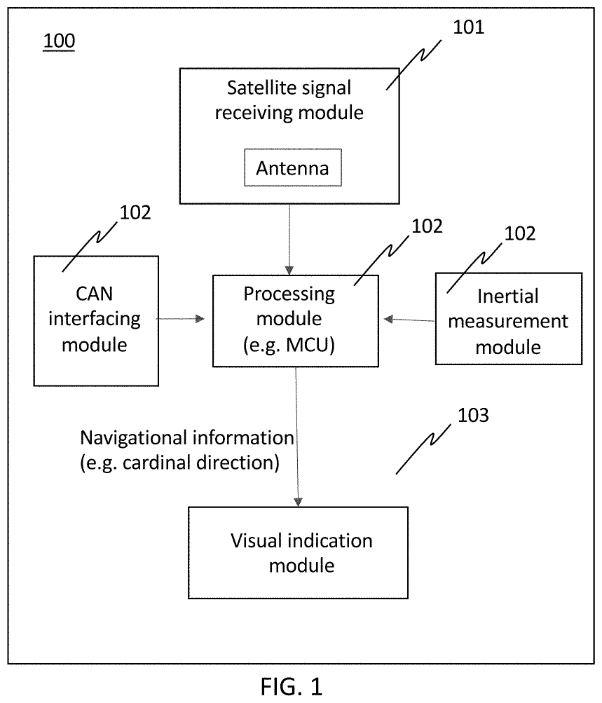

Referring to FIG. 1. According to one embodiment of the present invention, a navigation controller 100 with real-time visual indication of navigational information is provided. The navigation controller may comprise a CAN interfacing module 101 for communicating with a UAV; a satellite signal receiving module 102 comprising an antenna configured to receive satellite signals from a GNSS such as GPS, GLONASS and Beidou; a processing module 103 configured to extract navigational information from the received satellite signals; and a visual indication module 104 configured to generate visual indication of the extracted navigational information.

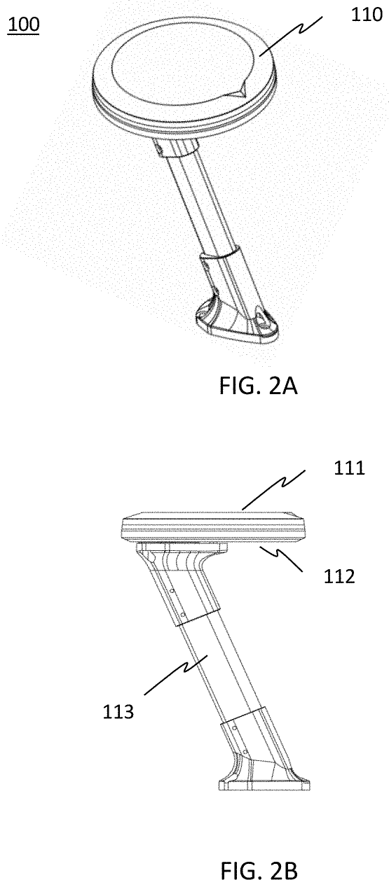

Referring to FIGS. 2A-2B. The navigation controller may further comprise a housing 110 for protecting the satellite signal receiving module, processing module and the visual indication module. The housing may have a top lid 111, a base 112 and handle 113, which are bonded together to ensure a waterproof and dust-resistance sealing with ingress protection rating such as IP68 or IP69.

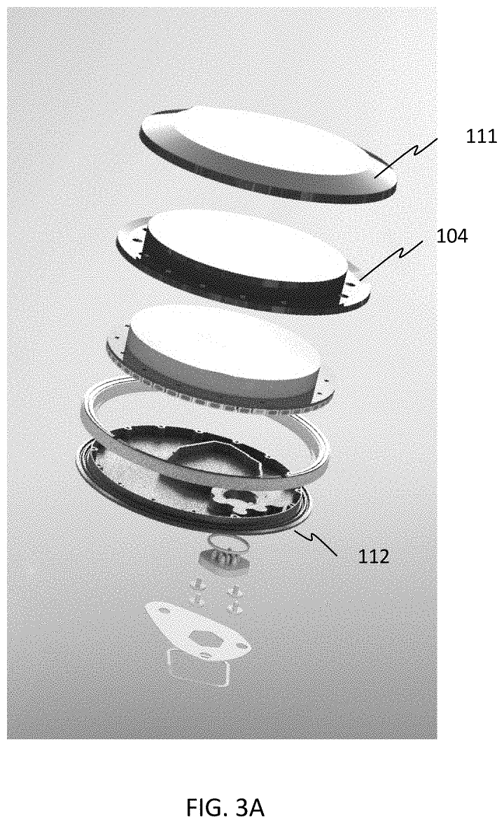

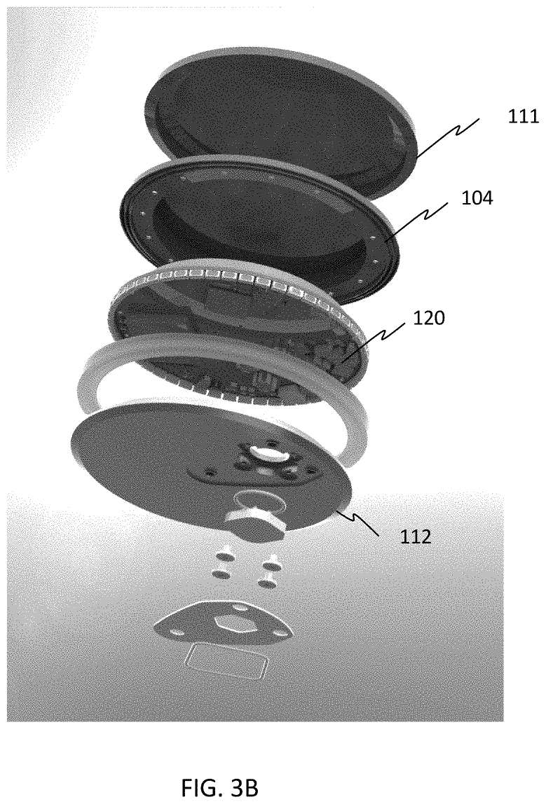

Referring to FIG. 3A. The top lid 111 may be semi-transparent to allow the visual indication generated by the visual indication module 104 to be viewed by users. The base 112 may be made of metals or alloys, such as aluminium alloys, for heat dissipation and RF shielding.

Referring to FIG. 3B. The CAN interfacing module 101, satellite signal receiving module 102 and processing module 103 may be supported by and connected through a printed circuit board (PCB) 120.

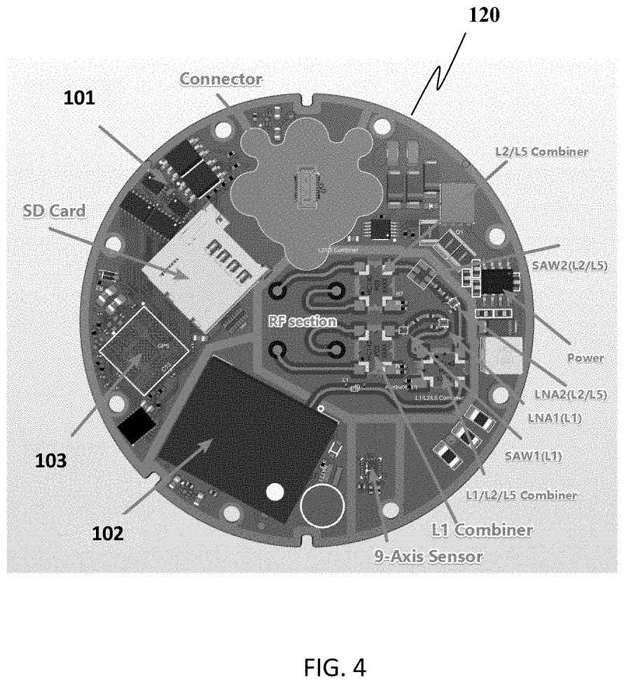

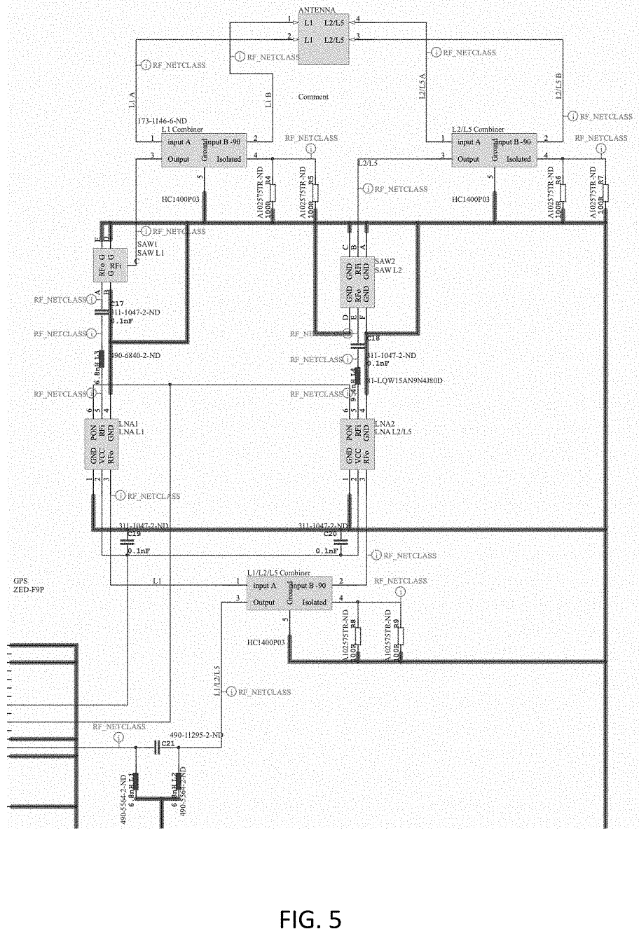

Referring to FIG. 4. The PCB 120 may be made of RF stabilized Rogers materials. Preferably, the PCB 120 may be implemented with a RF section with a circuit diagram as shown in FIG. 5, configured for blending two-phase outputs of each frequency band, filtering them, and amplifying them, then blending the two frequencies through a combiner and then feeding this into the satellite signal receiving module. Furthermore, the PCB may be bonded to the base such that the overall structural strength and RF shielding performance of the navigation controller can be further enhanced.

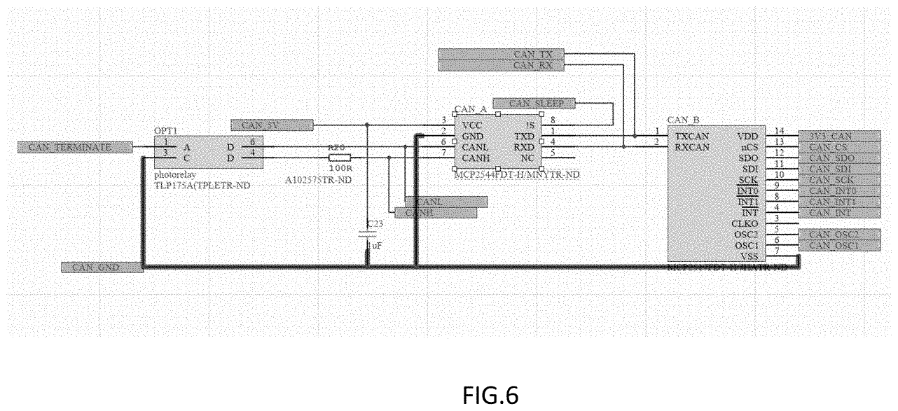

Preferably, the CAN interfacing module 101 may be a dual flexible data-rate (FD) UAV CAN interface with a circuit diagram as shown in FIG. 6. The dual FD UAV CAN interface may have up to 8 Mbit data payload rates and support functions including: timing synchronization of all components on the bus; redundancy; and software termination allowing the system to be optimized for the layout.

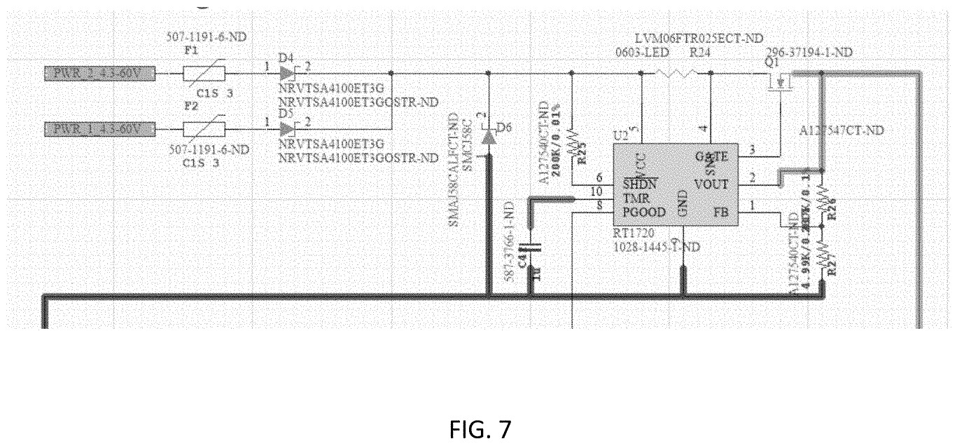

Referring to FIG. 7. The CAN interface 101 may comprise a dual CAN power supply with a redundant power input. The dual CAN power supply has ability to distribute power based on a point of load model which allows a safe mode of power supply by keeping the high voltage/high current battery voltage to a point of load, rather than distributing a low voltage between accessories from a common power supply.

The dual CAN power supply may have functions: removing the single point of failure of the common power supply; adding protection and redundancy per device; reducing the current requirement at each device due to running at a higher voltage; allowing power to be distributed in more logical methods around the vehicle; individual voltage monitoring per supply; hot swapping of power systems; and smart reduction in current requirements by reducing non-flight critical functionality in power fault situations.

Referring back to FIG. 1. The navigation controller may further comprise an inertial measurement module configured to obtain rotational information (roll pitch yaw angles) of the navigation controller. The processing module is further configured to calculate a genuine position of the navigation controller by mixing the raw GPS signals with the measured raw inertial data. The dual CAN interfacing module may be configured to communicate with the UAV such that a photograph of a point which is taken by a camera in the UAV may be precisely geotagged based on either a live real time kinematic (RTK) or a post-processed kinematic (PPK) methodologies for precision GPS positioning.

Further, the processing module 103 may be configured to calculate the precise camera angle at the time of the photograph is taken based on the precise inertial data from onboard and offboard sources. With an external optical flow module, the distance from a sensor of the camera to the center of the frame on the ground can be calculated precisely. This allows users to build up a relatively accurate photomosaic in real time, and also assists in the post processing of offline photo stitching by accurately tagging each picture.

In this exemplary embodiment, the navigation controller 100 is provided with real-time visual indication of a specific cardinal direction in relation to a front direction of the navigation controller.

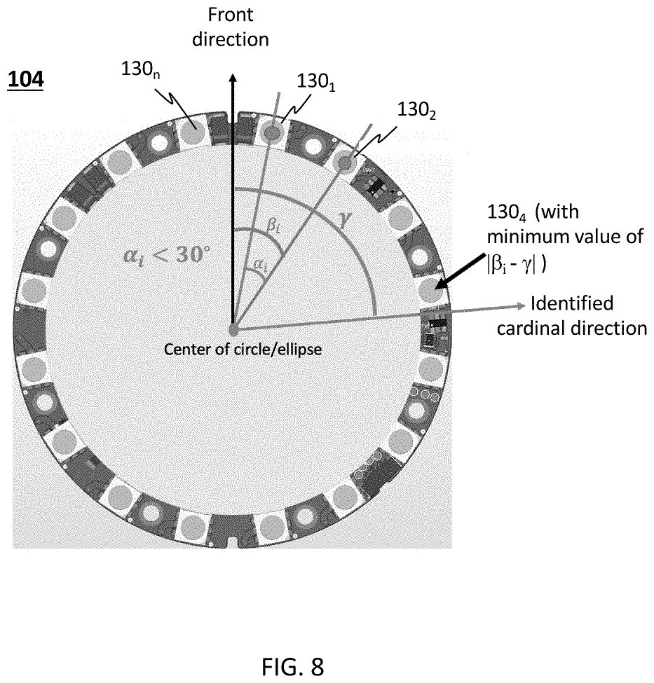

Referring to FIG. 8, the visual indication unit 104 may comprise a circular array of visual indicators 130ᵢ (i=1, 2, . . . , n, where n is the total number of the visual indicators) evenly arranged in a circular ring and configured to generate visual indication of the specific cardinal direction. Each of the visual indicators may be associated with a direction having an indexing angle, βᵢ, with respect to the front direction of the navigation controller. Preferably, the difference of indexing angles between any two consecutive visual indicators, αᵢ, is less or equal than 30°. That is, the visual indicators are arranged to satisfy the condition: αᵢ=|βᵢ₊₁−βᵢ≤30°.

In this exemplary embodiment, the visual indicators are RGB LEDs which colors and intensity are adjustable. However, it will be apparent to the practitioner skilled in the art that the visual indicators can be any other types of lighting devices with adjustable visual appearance such as intensities, colours, patterns and shapes.

Referring back to FIG. 2A. The housing 110 may have a disc-shape and comprise a distinctive visual mark, such as an arrow, position on the top lid 111 for indicating the front direction of the navigation controller. Preferably, the housing may further comprise an optical component configured to couple with the visual indicators for shaping and/or steering light beams embittered from each of the visual indicators. For example, the optical component may be a circular array of lens or prims moulded on the top cover and configured to couple with each of the visual indicators, or a prismatic film fixed on the top cover.

The processing module may further be configured to: identify a specific cardinal direction such as the North, South, West or East, on basis of the satellite signals received by the satellite signal receiving module; determine a relative angle γ between the front direction and the specific cardinal direction and compare each of the indexing angles of the plurality visual indicators to identify a visual indicator with the indexing angle of a value closest to the relative angle, that is a visual indicator having a minimum value of difference between its indexing angle and the relative angle, |βᵢ−γ|. The identified visual indicator is then configured to have an appearance such as colour or intensity which is distinctly different from the other visual indicators to provide visual indication of the specific cardinal direction.

As shown in FIG. 8, in this exemplary embodiment, indicator 130₄ is identified as the visual indicator having a minimum value of difference between its indexing angle βᵢ and the relative angle γ, that is having a minimum value of |βᵢ−γ|. Therefore, it is configured to be lighted up with a colour which is distinctly different from the other visual indicators.

Based on this visual indication of the specific cardinal direction, an operator using the navigation controller can check on whether the heading estimation of the UAV is subject to any magnetic interference.

In this exemplary embodiment, the visual indicators are used for providing visual indication of a cardinal direction. However, it will be apparent to the practitioner skilled in the art that the visual indicators can be used to act as navigation beacons, marker lights and warning strobe lights, or used to provide user feedbacks errors.

The embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

What is claimed is:

1. A navigation controller with real-time visual indication of a specific cardinal direction in relation to a front direction of the navigation controller, comprising:
a housing comprising a distinctive visual mark for indicating the front direction of the navigation controller;
a satellite signal receiving module comprising an antenna configured to receive satellite signals from a global navigation satellite system (GNSS);
a processing module configured to identify the specific cardinal direction on basis of the satellite signals received from the GNSS; and
a visual indication module comprising a circular array of visual indicators evenly arranged in a circular ring and configured to generate visual indication of the specific cardinal direction in relation to the front direction of the navigation controller.

2. The navigation controller of claim 1, wherein:
each visual indicator is associated with a direction having an indexing angle with respect to the front direction of the navigation controller;
the processing module is further configured to:
determine a relative angle between the front direction and the specific cardinal direction, and
compare each indexing angles of the plurality visual indicators to identify a visual indicator with the indexing angle of a value closest to the relative angle; and
the identified visual indicator is configured to have an appearance which is distinctly different from the other visual indicators.

3. The navigation controller of claim 2, wherein the difference of indexing angles between any two consecutive visual indicators is less or equal than 30°.

4. The navigation controller of claim 2, wherein the visual indicators are RGB LEDs.

5. The navigation controller of claim 2, wherein the identified visual indicator is configured to have a colour which is distinctly different from the other visual indicators.

6. The navigation controller of claim 1, wherein the visual mark of the front direction of the navigation controller is a distinctive arrow pointing to the front direction and positioned on a top lid of the navigation controller.

7. The navigation controller of claim 1, wherein the housing comprises
a top lid which is semi-transparent to allow the generated visual indication generated to be viewed by users; and
a base which is metals or alloys for heat dissipation and RF shielding.

8. The navigation controller of claim 1, further comprising a controller area network (CAN) interfacing module for communicating with an unmanned aerial vehicle (UAV).

9. The navigation controller of claim 1, further comprising an inertial measurement module configured to obtain rotational information of the navigation controller.
